(19) United States
(12) Patent Application Publication
(10) Pub. No.: US 2012/0309471 A1
(43) Pub. Date: Dec. 6, 2012

(54) SLIDING MODULE AND SLIDABLE ELECTRONIC DEVICE

(75) Inventor: PU LUO, Shenzhen City (CN)

(73) Assignee: HON HAI PRECISION INDUSTRY CO., LTD., Tu-Cheng (TW)

(21) Appl. No.: 13/293,394

(22) Filed: Nov. 10, 2011

(30) Foreign Application Priority Data
May 30, 2011 (CN) 201110142243.5

(51) Int. Cl. H04W 88/02

(52) U.S. Cl. 455/575.4

(57) ABSTRACT

A slidable electronic device includes a main body, a cover, and a sliding module sandwiched between the main body and the cover, and groups of resilient members. The sliding module includes a guiding member including a first guiding portion and a second guiding portion arranged side by side. The first guiding portion has a first guiding direction, and the second guiding portion has a second guiding direction that is reversed to the first guiding direction. Two sliding members slidable along the first and second guiding directions respectively. Two restricting members are respectively mounted on the first and second guiding portions, and each restricting member is opposite to one sliding member and being adjacent to the other sliding member. Each restricting member prevents the adjacent sliding member from detaching from the guiding member. Each group of resilient members is resisted between one restricting member and one sliding member.

### BACKGROUND

1. Technical Field

The present disclosure relates to an electronic device, and more particularly, to a slidable electronic device with a sliding module.

2. Description of Related Art

A common slidable electronic device such as a mobile phone, includes a main body, a cover and a sliding module sandwiched between the main body and the cover. A sliding module includes a base body, a pair of guiding rods arranged on the base body parallel to each other and two resilient members sleeved on the two guiding rods, respectively. Each guiding rod includes a restricting portion at an end thereof. The cover slides along the main body by rotating the sliding module and compressing the two resilient members to a predetermined amount, and then releasing the resilient member to push the cover to slide along the main body along the same direction. The cover is positioned with the restricting portions of the guiding rods. However, an improper manner of setting the guiding rods, for example, when the guiding rods are not parallel to each other, it may result in the resilient members being difficult to be compressed, thereby making it difficult to open and close the slidable electronic device, and thus the stability of the slidable electronic device is decreased.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded, isometric view of an embodiment of a slidable electronic device including a sliding module.

FIG. 2 is an enlarged, assembled, isometric view of the sliding module of the slidable electronic device of FIG. 1.

FIG. 3 is an exploded, isometric view of the sliding module of FIG. 2.

FIG. 4 shows an original state of the slidable electronic device of FIG. 1.

FIG. 5 shows a first state of the slidable electronic device of FIG. 1.

FIG. 6 shows a second state of the slidable electronic device of FIG. 1.

### DETAILED DESCRIPTION

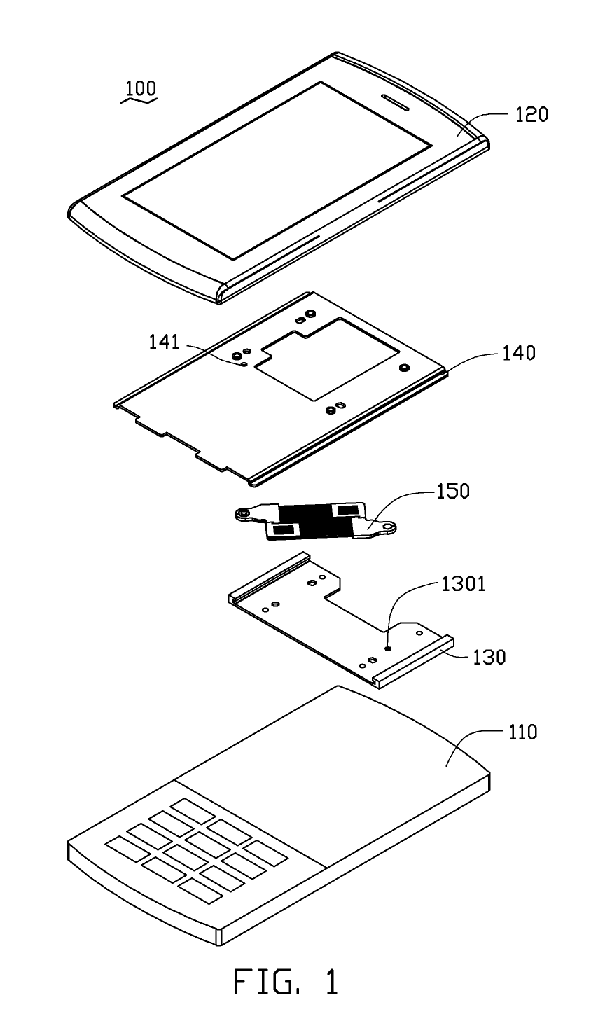

Referring to FIG. 1, an embodiment of a slidable electronic device 100, includes a main body 110, a cover 120, a guiding rail 130 mounted on the main body 110, a sliding plate 140 mounted on the cover 120, and a sliding module 150 sandwiched between the guiding rail 130 and the sliding plate 140. The sliding plate 140 is slidable along the guiding rail 130 via the sliding module 150 to enable the cover 120 to slide along the main body 110 semi-automatically. The slidable electronic device 100 can be a housing with a slidable cover for storing electronic units to achieve a particular function. In the embodiment, the slidable electronic device 100 is a mobile phone.

The guiding rail 130 defines a pivotal hole 1301 adjacent to one edge of the guiding rail 130 in a sliding direction. The sliding plate 140 defines a pivotal hole 141 adjacent to one edge of the sliding plate 140 opposite to the edge of the guiding rail 130 in the sliding direction.

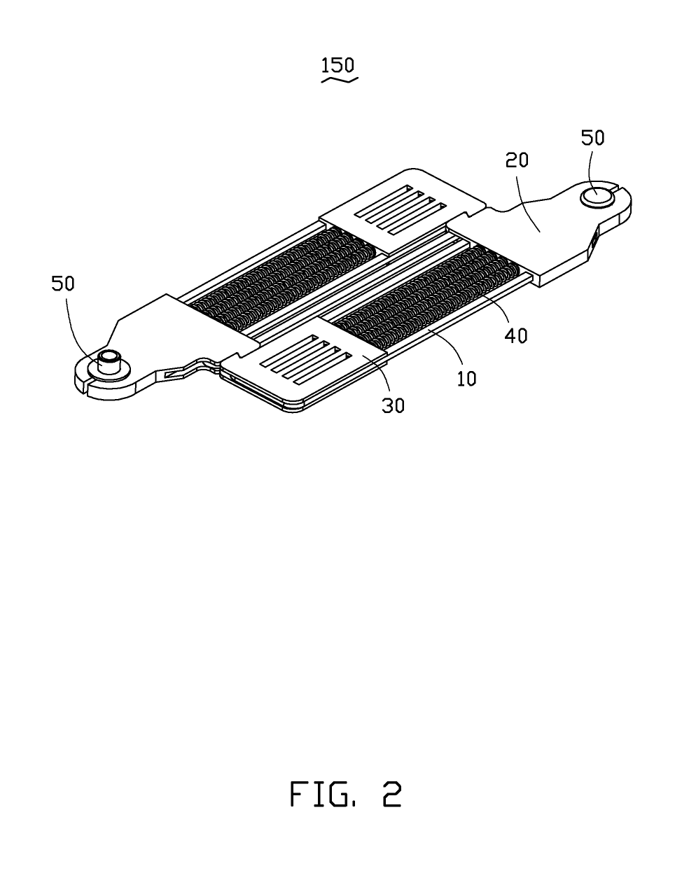

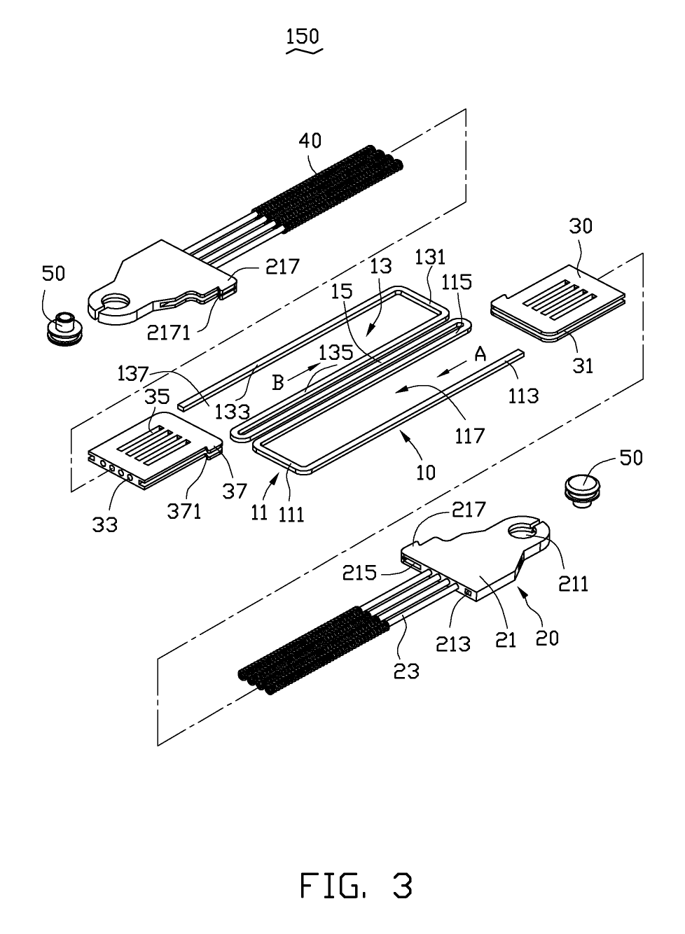

Referring to FIGS. 2 and 3, the sliding module 150 includes a guiding member 10, a pair of sliding members 20, a pair of restricting members 30, two groups of resilient members 40 and two pivotal members 50. The guiding member 10 is a folded metallic rod and includes a first guiding portion 11, a second guiding portion 13 and a connecting bar 15 connected to the first guiding portion 11 and the second guiding portion 13 at two opposite ends. The first guiding portion 11 and the second guiding portion 13 are arranged side by side to form a substantially S-shaped structure together with the connecting bar 15. The first guiding portion 11 has a first guiding direction A, the second guiding portion 13 has a second guiding direction B parallel and reversed to the first guiding direction A. One sliding member 20 and one restricting member 30 are arranged at two opposite ends of the first guiding portion 11 along the first guiding direction A, the other sliding member 20 and the other restricting member 30 are arranged at two opposite ends of the second guiding portion 13 along the second guiding direction B. Each sliding member 20 is capable of sliding along the first guiding direction A or the second sliding direction B toward a restricting member 30, respectively. Each group of resilient members 40 are resisted between one sliding member 20 and one restricting member 30. The pivotal members 50 are mounted between the cover 120 and the main body 110 to enable the sliding module 150 to be rotatably connected to the sliding plate 140 and the guiding rail 130.

The first guiding portion 11 includes a mounting part 111, a first guiding part 113 and a second guiding part 115. The first guiding part 113 and the second guiding part 115 extend from the two opposite ends of the mounting part 111. and perpendicularly bend toward one side of the mounting part 111. The first guiding part 113 and the second guiding part 115 are parallel to each other and opposite to the first guiding direction A. The first guiding part 113, the second guiding part 115 and the mounting part 111 cooperatively define an opening 117 in a “C” shape. The second guiding portion 13 is the same as the first guiding portion 11 and includes a mounting part 131, a first guiding part 133, a second guiding part 135, and defines an opening 137. The two second guiding parts 115, 135 are adjacent to each other, and are fixed together, the two openings 117, 137 are positioned side by side, and opposite to each other. The guiding member 10 can be integrally formed. In the embodiment, the connecting bar 15 connects the two second guiding parts 115, 135. In an alternatively embodiment, the connecting bar 15 can be omitted and the two second guiding parts 115, 135 are connected directly.

One sliding member 20 is slidably mounted on the first guiding portion 11 adjacent to the opening 117. The other sliding member 20 is slidably mounted on the second guiding portion 13 adjacent to the opening 137. Each sliding member 20 includes a base 21 and a plurality of guiding rods 23 extending from a side of the base 21 towards a predetermined direction parallel to the first guiding part 113. The guiding rods 23 are parallel to each other. In the embodiment, the sliding members 20 are made of plastic materials.

The base 21 is a polygon block and defines a mounting hole 211 at an end away from the guiding rods 23. The base 21 further defines a first sliding groove 213 and a second sliding groove 215 at the side of the base 21 coupled to the guiding rods 23. The first sliding groove 213 and the second sliding groove 215 are located at two sides of the guiding rods 23. The first sliding groove 213 and the second sliding groove 215 are a plurality of through holes, and are parallel to each other. The first guiding part 113 and the second guiding part 115 slidably engage in the first sliding groove 213 and the second sliding groove 215 respectively. The base 21 further includes an abutting portion 217 adjacent to the second sliding groove 215. The abutting portion 217 is a barb and includes an inclined abutting surface 2171 orientated to the mounting hole 211.

One restricting member 30 is mounted on the mounting part 111. The other restricting member 30 is mounted on the mounting part 131. Each restricting member 30 is opposite to one sliding member 20 and adjacent to the other sliding member 20. Each restricting member 30 defines a mounting slot 31 around three side surfaces thereof. The two mounting parts 111, 131 detachably engage in the two mounting slots 31 to fix the two restricting members 30 to the first guiding portion 11 and the second guiding portion 13 respectively. Each restricting member 30 further defines a plurality of guiding holes 33 at an end surface thereof away from the mounting slot 31 and a plurality of slots 35 at a front surface thereof. The slots 35 communicate with the guiding holes 33 respectively. The guiding holes 33 are a plurality of through holes, and are parallel to each other. The cross-sectional view of each slot 35 is in a strip shape, the length direction of the slot 35 is parallel to the guiding holes 33. Each slot 35 divides a corresponding guiding hole 33 into two parts.

Each restricting member 30 further includes a restricting portion 37 at a side thereof away from the guiding holes 33. The restricting portion 37 is a barb and includes an inclined restricting surface 371 orientated to the opening 117, 137. The restricting surfaces 371 of the restricting portions 37 respectively engage with the abutting surfaces 2171. In the embodiment, the restricting members 30 are made of plastic materials.

In the illustrated embodiment, each group of resilient members 40 are sleeved on the guiding rods 23 of one sliding member 20, and are resisted between one sliding member 20 and one corresponding restricting member 30. The resilient members 40 are a plurality of spiral springs.

One pivotal member 50 engages in one mounting hole 211 and the pivotal hole 1301, and the other pivotal member 50 engages in the other mounting hole 211 and the pivotal hole 141 to enable the sliding module 150 to be rotatably connected to the sliding plate 140 and the guiding rail 130.

In assembly, the mounting slot 31 of the restricting member 30 moves toward the mounting part 111 of the first guiding portion 11 when entering through the opening 117 until the mounting part 111 engages in the mounting slot 31 to fix the restricting member 30 to the first guiding portion 11. A group of resilient members 40 are respectively sleeved on the guiding rods 23. With the guiding rods 23 aligned to the guiding holes 33, the first sliding groove 213 and the second sliding groove 215 are aligned to the first guiding part 113 and the second guiding part 115 respectively. The sliding member 20 moves toward the mounting part 111 through the opening 117 to enable the group of resilient members 40 to be resisted between the mounting part 111 and the base 21, and the guiding rods 23 are slidably engaged in the guiding holes 33, respectively.

Similarly, the other restricting member 30 moves toward the mounting part 131 through the other opening 137 with the restricting portion 37 bypassing the abutting portion 217 of the adjacent sliding member 20, until the restricting member 30 is finally fixed to the mounting part 131. To release the adjacent sliding member 20, the adjacent sliding member 20 moves outward through the opening 117 under the resisting of the group resilient members 40, thus the abutting surface 2171 resists on the restricting surface 371, to prevent the sliding member 20 from detaching from the guiding member 10.

Similarly, the other group of the resilient members 40 are sleeved on the guiding rods 23, the sliding member 20 moves along through the opening 137, and the abutting portion 217 bypasses the restricting portion 37. The abutting portion 217 abuts against the restricting portion 37 to prevent the sliding member 20 detaching from the guiding member 10.

The guiding rail 130 and the sliding plate 140 are fixed to the main body 110 and the cover 120 respectively. The two mounting holes 211 are aligned to the pivotal holes 1301, 141 correspondingly. One pivotal member 50 engages in one mounting hole 211 and the pivotal hole 1301, and the other pivotal member 50 engages in the other mounting hole 211 and the pivotal hole 141 to enable the sliding module 150 to be rotatably connected to the sliding plate 140 and the guiding rail 130. The sliding plate 140 slidably engages with the guiding rail 130, thus completing the assembling of the slidable electronic device 100.

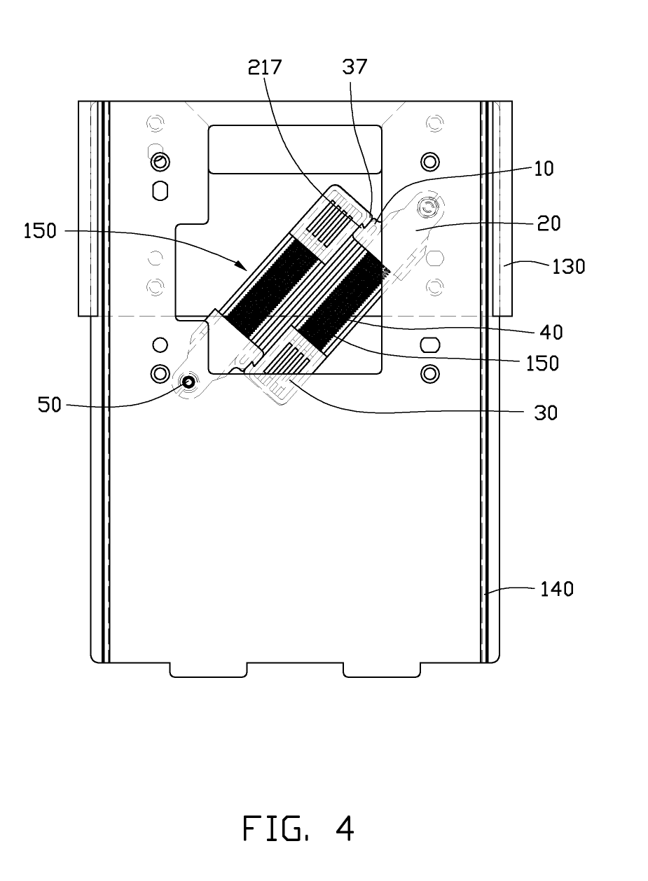

Referring to FIGS. 4 through 6, when the slidable electronic device 100 stays at an original state, the slidable electronic device 100 remains closed. The cover 120 shields the main body 110, the sliding plate 140 is slidably engaged with the guiding rail 130, and an end of the sliding plate 140 is aligned to an end of the guiding rail 130. The sliding module 150 is sandwiched between the sliding plate 140 and the guiding rail 130. In addition, the length direction of the sliding module 150 and the sliding direction of the sliding plate 140 defines an angle. The sliding module 150 stays in an operating state as shown in FIG. 4.

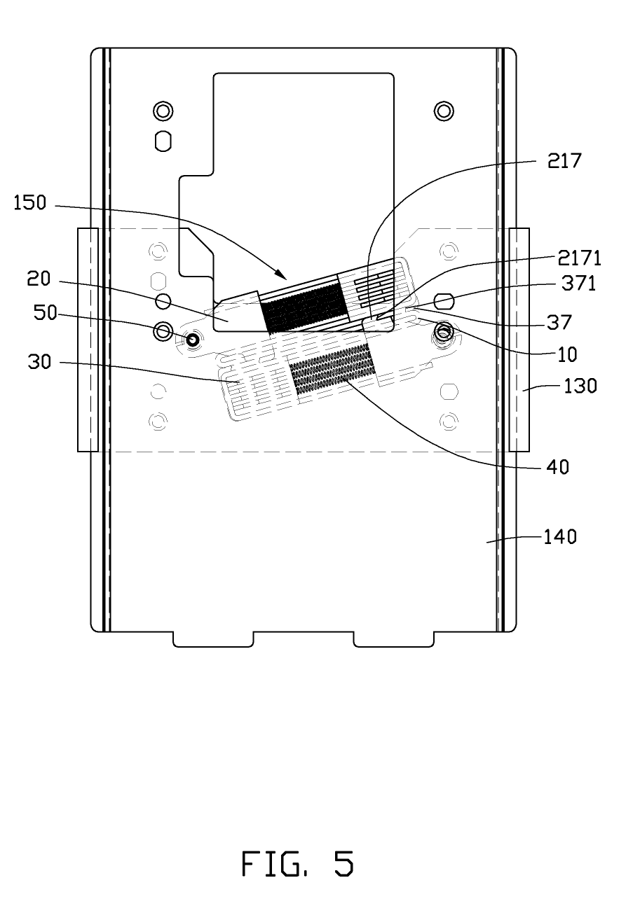

When the cover 120 is pushed to slidably exposing a part of the main body 110, the cover 120 drives the sliding plate 140 to slide along the guiding rail 130. Then, the sliding plate 140 drives a sliding member 20 to rotate relative to the other sliding member 20. The two sliding members 20 move toward each other and compress the two groups of resilient members 40 to accumulate an elastic potential energy until the connecting line formed between the centers of the two mounting holes 211 is perpendicular to the sliding direction of the cover 120. Thus, the slidable electronic device 100 reaches a first state as shown in FIG. 5. The guiding rail 130 is at a middle position of the sliding plate 140 to guide and restrict the sliding plate 140. The cover 120 slides along the main body 110 to a certain specified distance. In the transition process from the original state to the first state, the sliding member 20 slides away from the adjacent restricting member 30 gradually, and the abutting portion 217 detaches from the restricting portion 37.

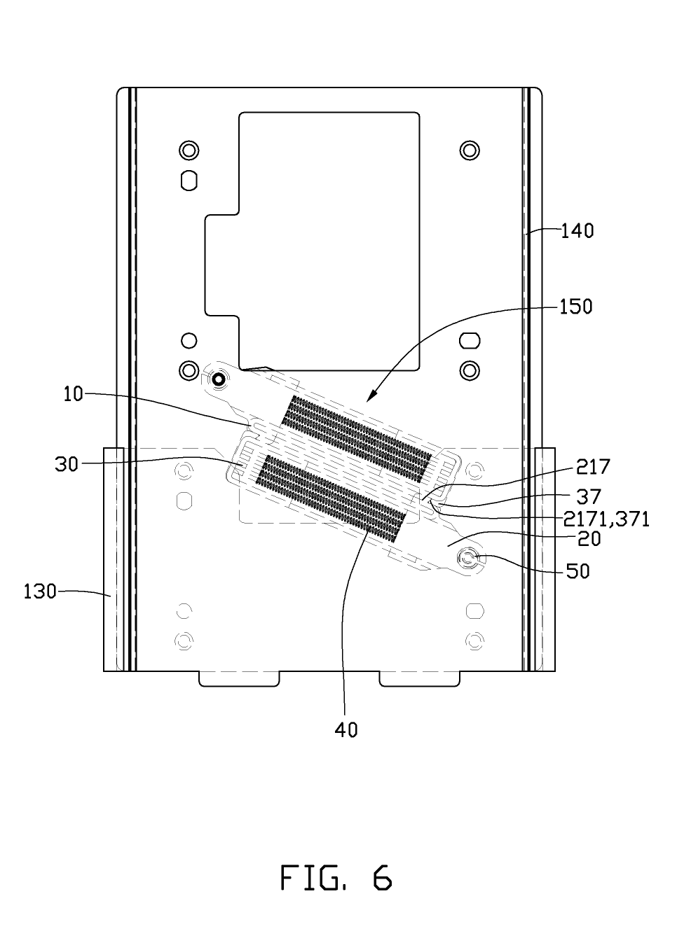

Continuing on pushing the cover 120 to slide relative to the main body 110 along the same direction, the sliding module 150 rotates along the same direction, and the two groups of resilient members 40 release the elastic potential energy to push the two sliding members 20 to move away from each other automatically. The two sliding members 20 drive the sliding plate 140 to slide along the guiding rail 130 along the same direction; moreover, the sliding plate 140 drives the cover 120 to slide along the main body 110. When the resilient members 40 rebound back, the abutting portions 217 of the sliding members 20 resist the restricting portions 37, and the sliding members 20 thereby stop sliding. The sliding plate 140 stops moving, the guiding rail 130 stays at the other side of the sliding plate 140, and the cover 120 is retained or configured at a predetermined position relative to the main body 110. The slidable electronic device 100 reaches a second state as shown in FIG. 6, in which a number of key pads of the main body 110 are exposed to enable the user to operate.

When closing the exposed portion of the main body 110, the cover 120 is pushed to slide back relative to the main body 110, and then the slidable electronic device 100 returns to the original state.

The first guiding portion 11 and the second guiding portion 13 guide the two sliding members 20, respectively, thus the cover 120 can slide along the main body 110 smoothly and obtain a high stability of the slidable electronic device 100 even if an improper manner of setting of the first and second guiding portions 11, 13 is to happen. As the restricting members 30 are detachably assembled to the guiding member 10 with the mounting part 111, 131 respectively engaged in the mounting slots 31, thus the sliding module 150 can be disassembled conveniently. The first and the second guiding portions 11, 13 are positioned side by side, thereby reducing the thickness of the slidable electronic device 100 and satisfying the demand of the slidable electronic device 100 for weight and thickness reduction.

It is to be understood that the main body 110 may include two guiding rails positioned side by side, and the cover 120 may include two sliding bars at two sides. The two sliding bars slidably engage with the two guiding rails respectively to enable the cover 120 to be slidably connected on the main body 110. One sliding member 20 connects with the cover 120; the other sliding member 20 connects with the main body 110, such that the guiding rail 130 and the sliding plate 140 can be omitted.

It is to be understood that resilient members 40 can be substituted by other materials, such as a plurality of elastic clips. The first guiding portion 11 and the second guiding portion 13 can be formed separately and fixed together. The guiding rods 23 and the base 21 can be formed separately and fixed together.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A slidable electronic device, comprising:
a main body;
a cover; and
a sliding module sandwiched between the main body and the cover, the sliding module comprising:
a guiding member comprising a first guiding portion and a second guiding portion arranged side by side, the first guiding portion having a first guiding direction, and the second guiding portion having a second guiding direction parallel and reversed to the first guiding direction;
two sliding members mounted on the first guiding portion and the second guiding portion, respectively, the two sliding members being slidable along the first guiding direction and the second guiding direction, respectively;
two restricting members mounted on the first guiding portion and the second guiding portion respectively, each restricting member being opposite to one sliding member and adjacent to the other sliding member, and each restricting member being capable of preventing the adjacent sliding member from detaching from the guiding member; and
two groups of resilient members, and each group of the resilient members resisted between one restricting member and one sliding member opposite to the restricting member.

2. The slidable electronic device of claim 1, further includes a guiding rail mounted on the main body and a sliding plate mounted on the cover, the sliding plate is slidable along the guiding rail, the sliding plate and the guiding rail both define a pivotal hole therein, the two sliding members both define a mounting hole therein, the sliding module further comprises two pivotal members, each pivotal member is mounted in one pivotal hole and one mounting hole to enable the two sliding members to be rotatably connected to the sliding plate and the guiding rail respectively.

3. The slidable electronic device of claim 1, wherein each sliding member comprises a base and a plurality of guiding rods extending from a side of the base toward a predetermined direction, the guiding rods are parallel to the first guiding direction, each group of resilient members are sleeved on the corresponding guiding rods respectively, each restricting member defines a plurality of guiding holes, the guiding rods slidably engage in the corresponding guiding holes respectively and the group of resilient members are resisted between the base and the restricting member.

4. The slidable electronic device of claim 3, wherein each restricting member comprises a restricting portion, the restricting portion comprises an inclined restricting surface orientated to the guiding rods, each sliding member comprises an abutting portion, the abutting portion comprises an inclined abutting surface opposite to the guiding rods, each restricting portion engages with the corresponding abutting portion via the inclined restricting surface resisting the inclined abutting surface to prevent the sliding member from detaching from the guiding member.

5. The slidable electronic device of claim 3, wherein the restricting member further defines a plurality of slots at a front surface thereof and communicating with the guiding holes, the guiding holes are a plurality of through holes and parallel to each other, and the length direction of the slots is parallel to the guiding holes, and each slot divides a corresponding guiding hole into two parts.

6. The slidable electronic device of claim 3, wherein the first guiding portion comprises a mounting part, the restricting member defines a mounting slot around three side surfaces thereof, and the mounting part engages in the mounting slot detachably to fix the restricting member to the first guiding portion.

7. The slidable electronic device of claim 6, wherein each guiding portion further comprises a first guiding part and a second guiding part extending from two opposite ends of the mounting part toward a predetermined direction, the base of the sliding member further defines a first sliding groove and a second sliding groove at two sides of the base, the first and second sliding grooves are a plurality of through holes, the first and second guiding parts slidably engage in the first and second sliding grooves respectively.

8. The slidable electronic device of claim 7, wherein the first and second guiding parts are parallel to each other and perpendicularly bent toward one side of the mounting part, the first, second guiding parts and the mounting part cooperatively define an opening toward the sliding member.

9. The slidable electronic device of claim 8, wherein the guiding member further comprises a connecting bar, the guiding member is a folded metallic rod and the two second guiding parts of the guiding member are connected by the connecting bar.

10. A sliding module, comprising:
a guiding member comprising a first guiding portion and a second guiding portion arranged side by side, the first guiding portion having a first guiding direction, and the second guiding portion having a second guiding direction parallel and reversed to the first guiding direction;
two sliding members mounted on the first guiding portion and the second guiding portion respectively, the two sliding members slidable along the first guiding direction and the second guiding direction, respectively;
two restricting members mounted on the first guiding portion and the second guiding portion respectively, each restricting member being opposite to one sliding member and adjacent to the other sliding member, and each restricting member being capable of preventing the adjacent sliding member from detaching from the guiding member; and
two groups of resilient members, and each group of resilient members resisted between one restricting member and one sliding member opposite to the restricting member.

11. The sliding module of claim 10, wherein each sliding member comprises a base and a plurality of guiding rods extending from a side of the base, the guiding rods are parallel to each other, each group of resilient members are sleeved on the corresponding guiding rods respectively, each restricting member defines a plurality of guiding holes, the guiding rods slidably engage in the corresponding guiding holes respectively and the group of resilient members are resisted between the base and the restricting member.

12. The sliding module of claim 11, wherein each restricting member comprises a restricting portion, the restricting portion comprises an inclined restricting surface orientated to the guiding rods, each sliding member comprises an abutting portion, the abutting portion comprises an inclined abutting surface opposite to the guiding rods, and the inclined restricting surface abuts against the inclined abutting surface to prevent the sliding member from detaching from the guiding member.

13. The sliding module of claim 11, wherein the restricting member further defines a plurality of slots at a front surface thereof, the guiding holes are a plurality of through holes and parallel to each other, the length direction of the slots is parallel to the guiding holes, and each slot communicates with the corresponding one guiding hole and divides the guiding hole into two parts.

14. The sliding module of claim 11, wherein the first guiding portion comprises a mounting part, the restricting member defines a mounting slot around three side surfaces thereof, the mounting part engages in the mounting slot detachably to fix the restricting member to the first guiding portion.

15. The sliding module of claim 14, wherein each guiding portion further comprises a first guiding part and a second guiding part extending from two opposite ends of the mounting part toward a predetermined direction, the base of the sliding member further defines a first sliding groove and a second sliding groove at two sides of the base, and the first and second guiding parts slidably engage in the first and second sliding grooves respectively.

16. The sliding module of claim 15, wherein the first and second guiding parts are parallel to each other and perpendicularly bent toward one side of the mounting part, the first, second guiding parts and the mounting part cooperatively define an opening in a “C” shape toward the sliding member.

17. The sliding module of claim 16, wherein the guiding member is a folded metallic rod, the two second guiding parts of the guiding member are fixed together, and the guiding member is integrally formed.
